(19) United States
(12) Patent Application Publication
(10) Pub. No.: US 2021/0070404 A1
(43) Pub. Date: Mar. 11, 2021

(54) Leash and Carrying Device for Body Boards

(71) Applicants: John L. LaProcido, Haddonfield, NJ (US); Elizabeth LaProcido, Haddonfield, NJ (US); Matthew LaProcido, Haddonfield, NJ (US); John R. LaProcido, Haddonfield, NJ (US); Marc LaProcido, Haddonfield, NJ (US)

(72) Inventors: John L. LaProcido, Haddonfield, NJ (US); Elizabeth LaProcido, Haddonfield, NJ (US); Matthew LaProcido, Haddonfield, NJ (US); John R. LaProcido, Haddonfield, NJ (US); Marc LaProcido, Haddonfield, NJ (US)

(21) Appl. No.: 15/688,034

(22) Filed: Aug. 28, 2017

(51) Int. Cl. B63B 32/73; B63B 32/22; B62B 17/06

(52) U.S. Cl. CPC B63B 32/73; B62B 17/06; B63B 32/22

(57) ABSTRACT

This invention relates to a leash, an adjustable wrist attachment, and attachment features for serving as a carrying and transport device for a body board or sledding device. The connection of the leash to the body board in many embodiments is comprised of plugs in the board near the top and bottom of the board, an elastic band or cord, hook and ladder wrist connections, a loop at the top of the leash, and securing the wrist band at an opposite end of the leash to a wearer while swimming, body surfing, or sledding activities.

This application claims priority to Provisional Applications 62/380,322 titled “Leash and Carrying Device for Body Boards,” filed Aug. 26, 2016, and 62/383,451, titled “Body Board Plug with Breakaway Release,” filed Sep. 4, 2016.

### FIELD OF THE INVENTION AND DESCIPTION OF THE PRIOR ART

The present invention relates generally to an apparatus for transporting an activity board, such as a body board or sledding device, and more specifically to a buoyant foam or plastic board or snowboards or a plastic sledding device used for recreational purposes, and carrying devices with plugs connections in these activity boards.

The body board, as is well known in the art, is a shorter version of the surfboard, designed to support a rider who is lying on the board in a prone position rather than an upright stance. A body board can be used to surf waves, including for youths and older persons, recreationally. Similarly, sledding devices and snowboards are used for supporting a rider's handling and control of the board. The boards are often constructed from modern polymers and similar materials.

### OBJECT OF THE INVENTION

Body boards, sleds, and activity boards in regular use today cannot be easily carried, whether transport is of a body board from a vehicle to the beach front, or a sled or other board from the bottom of a hill, slope, or mountain, to the top. When individuals or groups, such as families with children, travel to a beach for enjoying the waves, the individual or group typically carries a large load of gear. In winter, transport of a board is cumbersome not only due to the climb but also due to the heavy clothing, including heavy cold-weather boots. An object of the present invention is to provide a more facile carrying mechanism for transporting body boards that children or adults can use to carry body boards to the beach, or sleds and activity boards up hills, mountains, etc., for sliding down the hills, mountains, etc.

### BRIEF SUMMARY OF THE PRESENT INVENTION

In a preferred embodiment of the present invention, a body board for recreational use for riding ocean waves is presented, wherein the body board is constructed of non-toxic polymer materials. The method of construction is a molding process that is well known in the art. The top of the board is contoured so that a person can comfortable place the upper torso portion of their body on the board with their legs handing over the back edge of the board. This preferred embodiment also comprises a set of plugs disposed in the board, such that, as the board is being ridden, a leash attaches from the front or nose of the board and secures at the distal end of the leash to the user. During transport, the distal end that secures to the wearer may be secured to the board in a second plug so that the board may be worn, as if a shield on the wearer's back. The plugs and leash are designed to allow a safety breakaway level of resistance so riders can be freed of the board during transport: if the leash were too tight to the user's body, especially a child's body, there is a risk of injury to the user.

### BRIEF DESCRIPTION OF THE DRAWINGS

FIG. 1 depicts an embodiment of the invention showing a depiction of a body board with possible locations of plugs.

FIG. 2 depicts an embodiment of a plug for use at the top of the activity board.

FIG. 3A depicts an embodiment of users in relation to potential locations of the leash to depict the size of the leash contrasted with a user's body.

FIG. 3B depicts an embodiment of users in relation to carrying a board with a single leash across the user's back.

FIG. 4 depicts a design for a leash with attachments for a user's wrist or arm and an attachment to the top of the board, and a further attachment option for clasping the user-attaching end of the leash to the board.

FIGS. 5A and 5B depict a breakaway plug, and snap-receiving component for receiving the end of the leash.

FIG. 5C depicts a breakaway plug with a clasp connector.

### DETAILED DESCRIPTION OF THE INVENTION

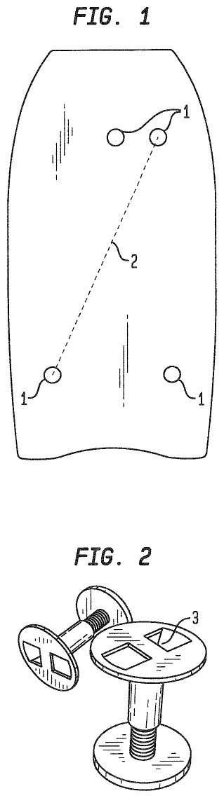

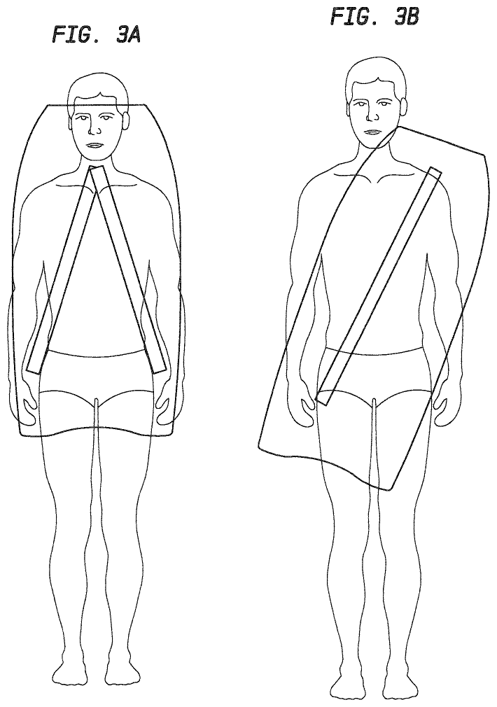

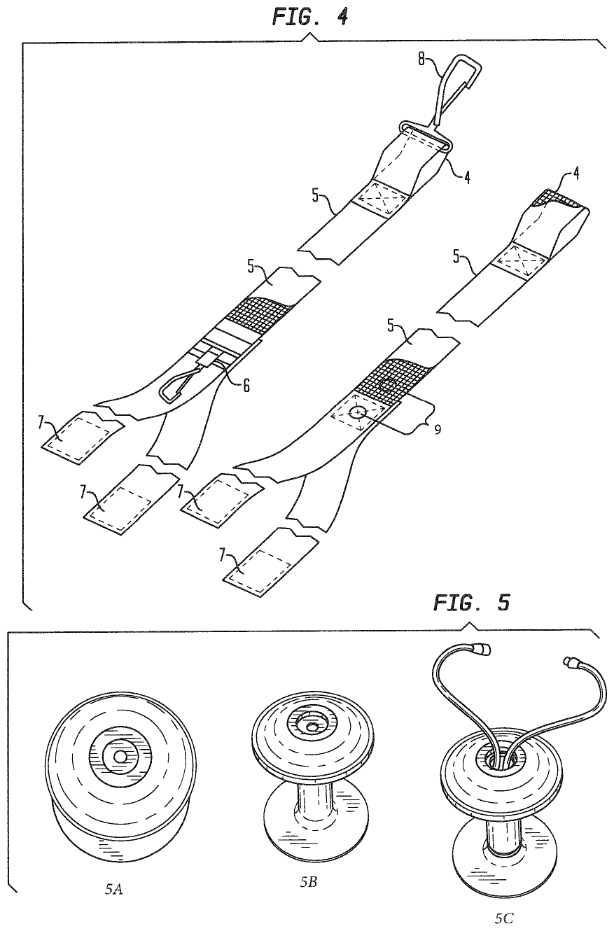

Turning now to FIG. 1, there is shown a potential design of a board with optional locations 1 for placing plugs for leashes. Each leash would have a distal end attached to one top and bottom plug location on the board in a preferred embodiment. In one embodiment an asymmetric strap would be attached to distal ends 2 but alternative embodiments may be comprised of other more or less symmetric configurations. The plugs for the top of the activity board may be as depicted in FIG. 2. In a preferred embodiment, the top plug as depicted in FIG. 2 has a loop for securing one end of the leash, which may be elastic cloth material, or of a fixed and predominantly inelastic cloth material. The leash or strap in the preferred embodiment would be fed through the slot under the securing bar 2 located on the surface or sunlight-facing section of the plug so that the leash will not be readily unsecured from the loop. The leash should be of sufficient length that the user may comfortably don the board on the user's back and with the single-strap (FIG. 3b) running asymmetrically to allow for added comfort in the transportation experience.

The leash may have optional elastic band or portions of the leash 5 may have elastic properties. An alternative embodiment of the loop and securing bar 2 may be a plastic, rotatable snap hook 8. An embodiment may also comprise, for a safety breakaway feature, a breakaway clip connector 6, or alternatively breakaway snap ends of a protruding and receiving end, which may be located at position 9.

In a preferred embodiment, the leash ends that optionally attach to a user may be connected with hook and loop connections. 7

FIG. 5 depicts a breakaway plug and release component for a preferred embodiment. The snapping receiver end plug is preferably located asymmetrically towards the bottom third of a body board. FIG. 3b. The snap leash will be attached to the bottom plug during transport, and a user may unsnap the leash and attach the leash to the wrist when using in water or during active use.

In most embodiments, the user will attach the leash to the board plug with the hook-and-loop (“velcro”) wristband feeding the wristband through the rope loop in the board. The user then uses the leash as a cross-body strap and carries the board on the user's back in a hands-free manner.

Optionally, the leash carrying device is also comprised of a breakaway safety clasp, preferably at the wrist-band end of the leash. The breakaway component is comprised of a clip connector attached to the wristband. The connector fastens to a hook or other clutching or grasping component that attaches to the board plug at the bottom of the body board The plug at the bottom of the board may have a rope loop to allow the breakaway safety device to attach to the leash.

The materials connecting to the wristband and breakaway clip, or from the breakaway clip to a hook or other connection device, may be webbing, rope, or plastic cord.

1. An apparatus for use with body boards and sledding boards, comprised of
a leash, where the leash has first and second distal ends connectable to the board,
where the first distal end of the leash remains connected to the board during transport or riding activities,
where the second distal end of the leash is comprised of a fastener for optional connection of the first end of the leash to a user's body,
and where the second end is further comprised of a board connector for optionally connecting the first end to a corresponding connector on the board during transport to or from a riding area.

2. The apparatus of claim 1, where the board connector for attaching the second distal end to the board is a protruding or receiving snapping end, and a plug in the board is comprised of a corresponding receiving or protruding snapping end.

3. The apparatus of claim 1, where the fastener is a hook and loop fastener for optional connection of the first distal end of the leash to the user, and where the hook and loop fastener is used for connecting the second distal end of the leash to a user's ankle, wrist, or arm.

4. The apparatus of claim 1, where connections to the board are comprised of a first and second plug, and where the first plug is located in a central and forward portion for receiving a loop of the strap on an upper surface of the boar, and the second plug is located on the upper surface of the board for optionally connecting to the first distal end of the leash.

5. The apparatus of claim 1, where the connection of the second distal end of the leash to the board is comprised of a breakaway snapping clasp.

6. An apparatus for transporting a board for sledding and surfing activities,
where the device is comprised of a carrying strap, a top plug, and a bottom plug,
where the top plug retains a strap by a loop receiver,
where the end of the strap is comprised of a fastener comprised of hooks and loops,
and where the bottom plug is comprised of a snapping receiver for optional connection of the end of the strap.

7. A body activity apparatus comprising:
a board for use in sledding, surfing, or riding activities,
a first plug assembly located near one end of the board, where the first plug assembly is comprised of a loop retainer, where the loop retainer receives a transportation and safety strap,
a second plug for optionally attaching the end of the transportation and safety strap, where the second plug and end of the transportation and safety strap connect by snapping protruding and receiving ends together, and where the second plug is not attached to the strap during riding activities.

8. The apparatus of claim 7, where the bottom plug portion of the leash has the snapping receiver, and the leash has a complementary protruding snap.

9. The apparatus of claim 7, where the bottom plug and leash are optionally connected by a breakaway snapping clasp.
